(19) United States
(12) Patent Application Publication
(10) Pub. No.: US 2006/0027598 A1
(43) Pub. Date: Feb. 9, 2006

(54) Integrated beverage and ice dispenser assembly

(75) Inventors: Fenando A. Ubidia, Ludlow, MA (US); Mark S. Tauer, Belchertown, MA (US); William Black, Southbury, CT (US)

Correspondence Address: RYNDAK & SURI LLP, 200 W MADISON STREET, SUITE 2100, CHICAGO, IL, 60602, US

(73) Assignee: PepsiCo, Inc.

(21) Appl. No.: 11/133,650

(22) Filed: May 20, 2005

Related U.S. Application Data
(60) Provisional application No. 60/573,426, filed on May 21, 2004.

(51) Int. Cl. B67D 5/56

(52) U.S. Cl. 222/129.1

(57) ABSTRACT

A beverage dispenser with plural dispensing heads from which different beverages are dispensed. The dispenser has an ice bin from which ice is dispensed. A motor drives an agitator internal to the ice bin. The motor is removably attached to the ice bin by locking pins for easy removal and replacement. Waste ice and beverage is collected in a drip pan. The drip pan is insulated to prevent condensate from collecting around the outer surface of the drip pan. A carbonator is mounted to a front of the dispenser to provide carbonated water. Consequently, the carbonator is easily accessible for maintenance or replacement. Carbonated or non-carbonated water flows through a common manifold to the individual dispensing heads. By setting a manifold valve member associated with each dispensing head, the type of water supplied to the dispensing head, either carbonated or non-carbonated, is selectively set.

### RELATIONSHIP TO EARLIER FILED APPLICATION

This application claims the benefit of U.S. Provisional Patent Application No. 60/573,426, filed May 21, 2004.

### FIELD OF THE INVENTION

This invention is generally related to a beverage dispenser used to dispense different blended beverages and ice. More particularly, this invention is related to a beverage and ice dispenser that is easy to maintain.

### BACKGROUND OF THE INVENTION

At restaurants or other locations, a beverage is often delivered from a dispenser in the form of a blend of syrup and water. Depending on the beverage, the water may or may not be carbonated. An advantage of dispensing beverage in this form is that the syrup containers and water supply occupy significantly less space than is otherwise required to store the same volume of beverage in individual containers. Providing beverage from a dispenser likewise eliminates the need for the establishment to have to deal with the waste formed by the empty individual containers.

A typical beverage dispenser includes a number of dispensing heads. Each head is connected to a different source of syrup, sometimes called concentrate, and a water source. Often, especially at a self-serve station, the beverage dispenser includes an ice dispenser. The ice dispenser includes a chute adjacent the beverage dispensing heads. This allows a customer, at a single location, to both fill a container with ice and a beverage of choice. An advantage of this arrangement is that it allows the customer, without staff involvement, to fill the cup with the specific proportions of ice and beverage preferred by the customer. This frees the staff from having to fill beverage containers so they can be available for other duties. Moreover, the customer enjoys complete control over the dispensing of his beverage.

While known beverage and ice dispensers work reasonably well, there are a few disadvantages associated with their use. In particular, many known beverage dispensers are difficult to maintain. For example, a beverage dispenser typically includes a drip pan. This pan is located below the ice chute and dispensing heads. The pan functions as a collection device for liquids and ice that do not make it into a container. Ice often collects in the pan. The ice lowers the temperature of the pan. Consequently, water vapor condenses around the outer surface of the pan. This condensate forms an unattractive puddle adjacent the dispenser. Restaurant personnel must therefore take time to clean the accumulated water.

As mentioned above, a beverage, in addition to being formed from syrup, is formed from either carbonated or non-carbonated water. Carbonated and non-carbonated beverages are typically dispensed from the different heads of a single beverage dispenser. To accommodate for changes in customer preferences, it is sometimes necessary to reconfigure a beverage dispenser to change the beverage delivered from a specific dispensing head. Sometimes this involves changing the water supplied to the dispensing head from carbonated to non-carbonated or vice versa. Some beverage dispensers are so constructed that, once manufactured, this change is difficult, if not impossible, to make. When it is possible to make this change, often a lengthy amount of time is required to replumb the connections to an individual dispensing head.

A cold plate is a component integral with many beverage dispensers. A cold plate consists of a thermally conductive plate that is positioned adjacent the bin used internal to the dispenser that holds ice prior to discharge. The cold plate is provided with tubing through which the syrups and water flow prior to discharge through the dispensing head. As these liquids flow through the cold plate, their thermal energy is transferred to the ice in the ice bin. Thus, these beverage-forming liquids are cooled prior to discharge. Due to the relatively cold temperature of the cold plate, condensate has a tendency to form inside the dispenser around the cold plate. This condensate collects as water pools inside the dispenser. Again, the formation of these pools requires that the staff tending to the dispenser take the time to clean them.

Still other problems are associated with the motor associated with the ice bin. This motor drives an agitator in the bin that prevents the individual ice cubes from forming a large block. Due to the loads to which this motor is exposed, it often requires maintenance. In known dispensers, the motor is attached in such a way that its removal is a difficult task that may take an extensive amount of time to perform.

### SUMMARY OF THE INVENTION

This invention is directed to a new and useful beverage dispenser that dispenses both ice and different types of beverages. The beverage dispenser of this invention includes an insulated drip pan. This feature of the invention substantially reduces, if not eliminates, the formation of condensate around the pan.

The beverage dispenser of this invention has a manifold to which both carbonated and non-carbonated water are supplied. The manifold has a number of outlets; each outlet is connected to a separate dispensing head. By setting a manifold valve integral with each outlet, carbonated water, non-carbonated water or a blend of the two waters is supplied to the dispensing head.

A cold plate is provided for chilling both the water and syrup prior to their discharge from a dispensing head. A layer of foam sealing secures the cold plate to the dispenser structural member to which the cold plate is mounted. The foam thermally insulates the cold plate from the dispensing head structural member to prevent the formation of condensate around the structural member.

The beverage dispenser of this invention has a motor that actuates the agitator internal to the dispenser ice bin. The motor is removably attached to the ice bin without removable fasteners. Consequently, removing the motor for maintenance is a task that is both relatively simple to perform and does not take much time to perform.

The beverage dispenser of this invention has a carbonator that produces the carbonated water. An electrical control unit regulates the operation of the dispenser. Both the carbonator and components forming the electrical component unit are mounted to a dispenser at locations where they are readily accessible.

The above and other features, independently and collectively, minimize the time and effort required to maintain the beverage dispenser of this invention.

### BRIEF DESCRIPTION OF THE DRAWINGS

The above and other features and benefits of this invention are described below in the detailed description taken in conjunction with the following drawings in which:

FIG. 1 is partially exploded front and side perspective view of a beverage dispenser of this invention;

FIG. 2 is an exploded view of the basic internal components of the beverage dispenser;

FIG. 2A is a partial cross sectional view illustrating how the cold plate is sealing secured to the dispenser base;

FIG. 3 is a perspective view of the basic internal components of the beverage dispenser;

FIG. 4 is a perspective and partial exploded view of the light bracket of the beverage dispenser;

FIG. 5 is an exploded view illustrating the drip pan and how the drip pan is attached to the rest of the dispenser;

FIG. 5A is a partial cross-sectional view of the drip pan;

FIG. 6 is a perspective view of a water supply manifold of the beverage dispenser of this invention;

FIG. 7 is a plan view of the water supply manifold;

FIG. 8 is an exploded view of the water supply manifold;

FIG. 9 is a cross sectional view of the water supply manifold taken along line 9-9 of FIG. 7;

FIG. 10 is a cross sectional view of the water supply manifold taken along line 10-10 of FIG. 7 wherein a manifold valve is shown in a first position so that water from a first inlet bore is supplied to a dole fitting;

FIG. 11 is a cross sectional view of the water supply manifold taken along line 11-11 of FIG. 7 wherein a manifold valve is shown in a second position so that water from a first inlet bore is supplied to a dole fitting;

FIG. 12 is a perspective and partial cutaway view of the ice bin, agitator and ice bin motor of the dispenser of this invention;

FIG. 13 is a top view looking into the dispenser ice bin.

FIG. 14 is an exploded view of the agitator drive assembly;

FIG. 15 is a second exploded view of the agitator drive assembly.

FIG. 16 is a perspective view of the motor, in particular, the face of the motor that is disposed against the ice bin;

FIG. 17 is a perspective view of the motor and, in particular, the side of the motor that is away from the ice bin; and

FIG. 18 is a block and diagrammatic illustration of how carbonated and non-carbonate water are selectively supplied to a dispensing head.

### DETAILED DESCRIPTION

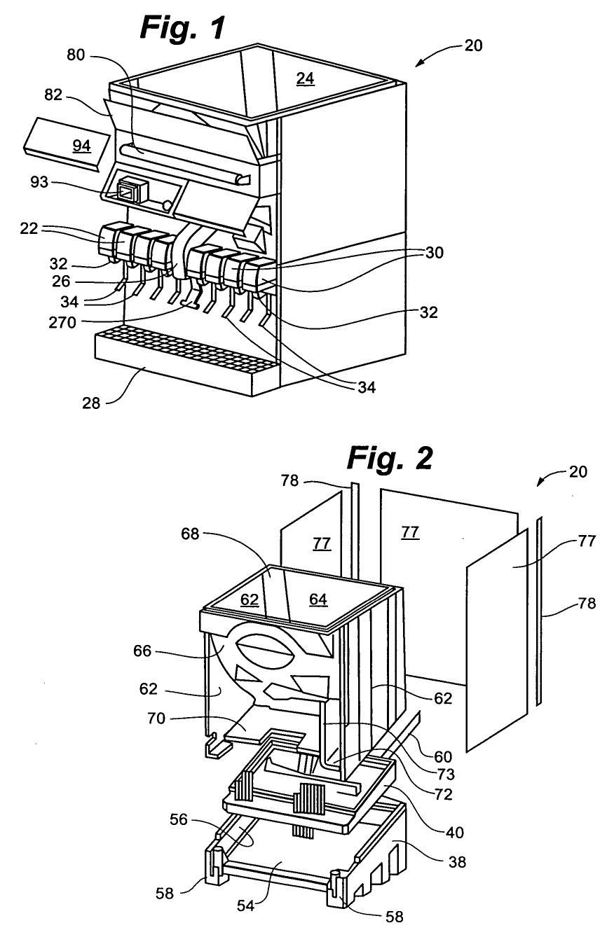

FIG. 1 illustrates a beverage dispenser 20 constructed in accordance with this invention. Beverage dispenser 20 has a plurality of dispensing head assemblies 22 from which separate blended beverages are individually dispensed. The dispenser 20 has an ice bin 24. Ice in bin 24 is discharged to the customer through a chute 26. In the depicted version of the invention, chute 26 is located between two sets of dispensing head assemblies 22. It should be understood that this is exemplary, not limiting. In alternative versions of the invention, chute 26 may be positioned at the end of a row of dispensing head assemblies 22. A drip pan 28 is positioned below the dispensing head assemblies 22 and the chute 26. The drip pan 28 catches liquid and ice that are not discharged into a beverage container.

Each dispensing head assembly 22 has a head unit 30 from which a downwardly-directed nozzle 32 extends. A lever arm 34 is pivotally attached to the head unit 30 and is positioned to extend under the nozzle 32. Beverage from a specific dispensing head assembly 22 is discharged by placing a container underneath the nozzle 32 to cause the displacement of lever arm 34. A sensor (not illustrated) internal to the head unit 30 senses the displacement of the lever arm 34. The signal generated by the sensor is sent to a control circuit (not illustrated). The control circuit, in response to this signal, opens valves (not illustrated) in the head unit 30 that regulate the discharge of syrup and water. The valves are simultaneously opened to cause the discharge of a blended beverage comprising the syrup and water from the dispensing head assembly 22. The detailed structure of the individual dispensing head assemblies 22 is not relevant to the other features of beverage dispenser 20 of this invention. Therefore, the structure of dispensing head assemblies 22 is not further discussed.

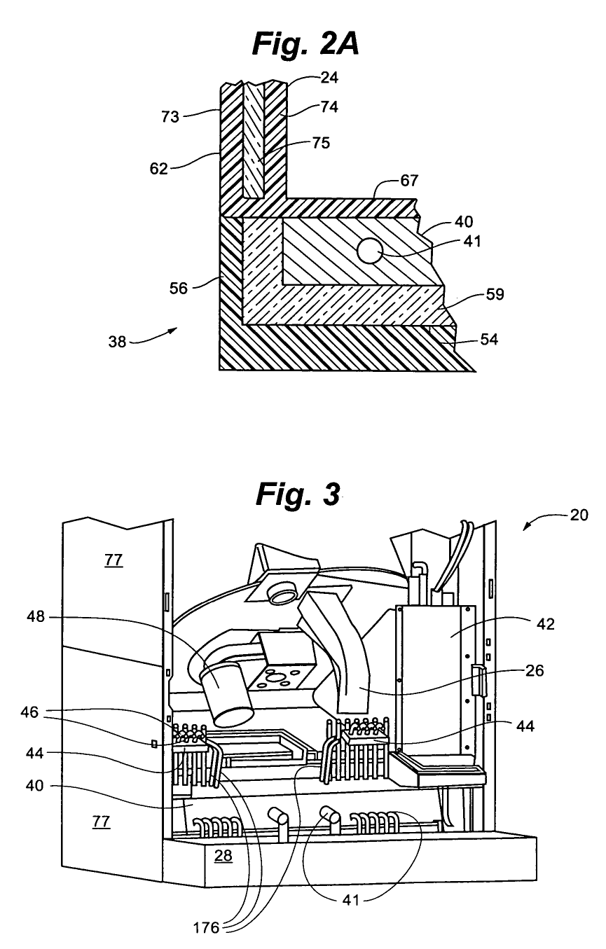

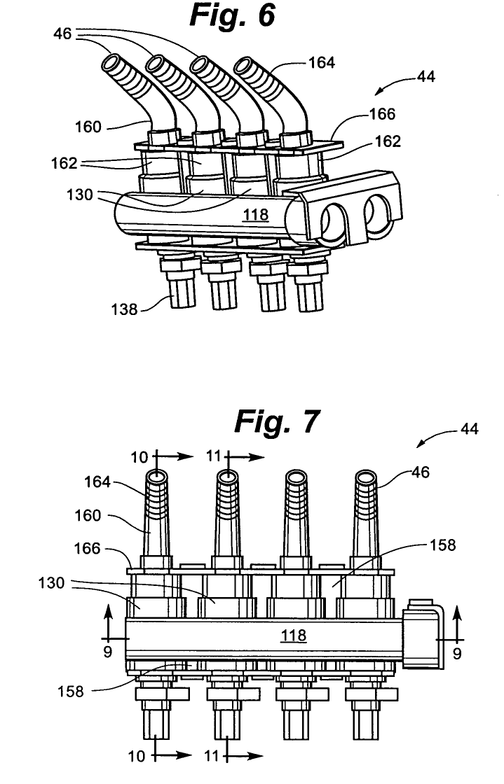

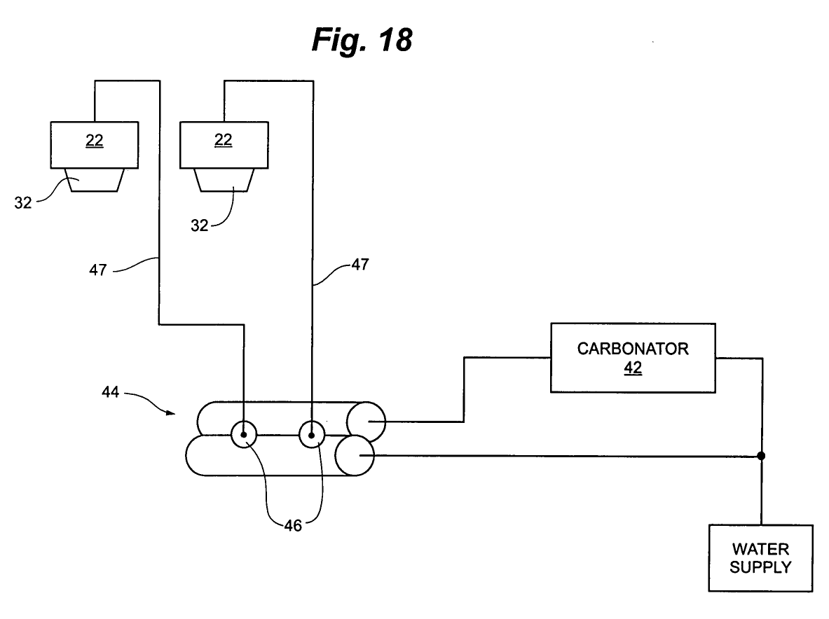

As seen best by FIGS. 2 and 3, dispenser 20 has a base 38. A cold plate 40 is disposed above base 38. The ice bin 24 is seated above the cold plate 40. A carbonator 42, the housing of which is shown, is mounted to the ice bin 24. Carbonator 42 converts water from the establishment's water supply into carbonated water. Two manifolds 44 are also disposed inside the dispenser 20. Each manifold 44 receives, as two separate input liquid streams, the carbonated water and the non-carbonated water. The manifolds 44 each have a number of outlet fittings, dole fittings 46. Each dole fitting 46 is connected to a hose line 47 (shown schematically in FIG. 18) that extends to an individual dispensing head assembly 22. By setting a manifold valve member 134 (FIG. 6) integral with each dole fitting 46, water from one of the two streams is flowed through the fitting to the associated dispensing head assembly 22.

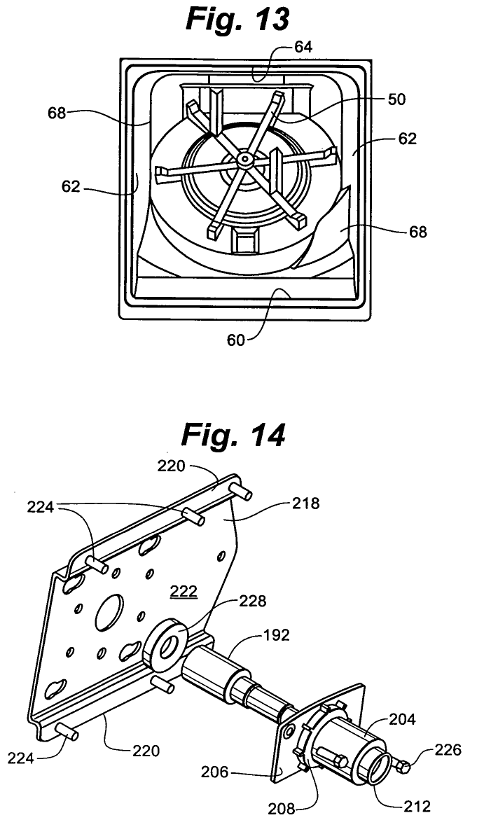

A motor 48 is removably mounted to the outside of the ice bin 24. Motor 48 rotates an agitator 50 (FIG. 13) internal to the ice bin 24. Agitator 50 is rotated to prevent individual ice cubes in bin 24 from congealing into large blocks.

Base 38, in some versions of the invention, is formed from plastic that has been rotationally molded. In the illustrated version of the invention, base 38 is formed to have a top surface 54 that is inclined upwardly from the front end. Base 38 is further formed to have a lip 56 that projects upwardly around the sides and back perimeters of the top surface 54. The base 38 is also shaped to have two spaced apart posts 58 that are located along the front of the base. Each post 58 projects above top surface 54 and is contiguous with one end of the lip 56.

Cold plate 40 is seated on the base top surface 54. The cold plate 40 is formed from thermally conducting material, often a metal. Internal to and extending out of the cold plate 40 are a number of different conduits 41. Each conduit 41 functions as separate flow path for one of the syrups or waters (carbonated or non-carbonated) supplied to the dispensing head assemblies 22.

The cold plate 40 is seated in the generally rectangular void space defined by the base top surface 54, lip 56 and posts 58. Foam 59, seen in FIG. 2A, is disposed between the base 38 and cold plate 40. In some preferred methods of assembling the dispenser 20 of this invention, a foaming-in-place process is used to apply foam 59 and seal the cold plate 40 to the base 38. Foam 59 thus serves to hold the cold plate 40 in position and as a thermally insulating layer around the side and bottom surfaces of the cold plate. This insulation reduces the extent to which condensate forms in the vicinity of the cold plate 40 and around the outer surface of base 38.

A mounting plate 60 further mechanically secures the cold plate 40 to the base 38. Threaded fasteners (not illustrated) screwed through the mounting plate 60 into the base 38 and cold plate 40 provide the actual physical attachment.

Ice bin 24 is disposed immediately above the exposed top surface of the cold plate 40. In the depicted version of the invention, the ice bin 24 has two opposed, horizontal, parallel side walls 62. A back wall 64 extends between the rear edges of the side walls 62. A front wall 66 extends between the front of the side walls 62. The ice bin 24 is shaped so that, from the top of the side walls 62, front wall 66 extends diagonally downward, towards the bottom of the back wall 64. Front wall 66 terminates at a base plate 67 (FIG. 2A) that extends between the side walls 62 and from the front wall 66 to the back wall 64. Ice bin side walls 62, back wall 64, front wall 66 and base plate 67 define an ice chamber 68. Ice bin 24 is further formed to have a planar web 70. Web 70 extends between the side walls 62 and forward from the bottom exposed surface of the front wall 66.

Ice bin 24 is also shaped to have a mounting bracket that extends outwardly from the inner surface of one of the side walls 62. This mounting bracket consists of a horizontally extending web 72 and a vertical flange 73. The mounting bracket is located immediately inward of the forward edge of the side wall 62 to which the bracket is mounted. The mounting bracket functions as the structural member to which the carbonator 42 is mounted. An advantage of so positioning the carbonator 42 is that it is easily accessible for maintenance or replacement.

In a preferred version of manufacturing the ice bin 24, the bin is rotationally molded. The side, back and front walls 62, 64, 66, respectively, are each formed from two spaced apart panels. This is seen in FIG. 2A wherein one side wall 62 is shown as having two spaced apart, parallel panels 73 and 74. Insulation 75 is disposed between the panels 73 and 74. Insulation 75 minimizes the extent to which the ice in chamber 68 melts and the condensation forms on the outer surface of the ice bin 24. Ice bin base plate 67 is neither insulated nor double-paneled. This facilitates the transfer of heat from the cold plate 40 into the ice chamber 68.

Rectangular shaped cladding panels 77 are removably attached to the bin side and back walls 62 and 64, respectively. L-shaped rails 78 extend over the perpendicularly meeting edges of adjacent cladding panels 77. Cladding panels 77 function as the outer back and side walls of the dispenser 20. The cladding panels 77 can be removed and replaced for aesthetic or advertising reasons.

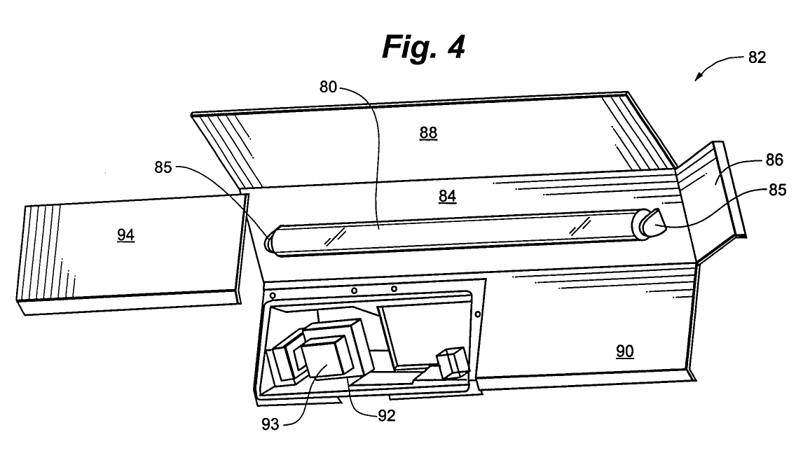

As shown in FIGS. 1 and 4, a fluorescent light 80 illuminates the front of the dispenser 20. Light 80 is mounted to a bracket 82 that extends forward of the ice bin 24 and is located above the dispensing head assemblies 22. Bracket 82 has a center panel 84 that extends between the ice bin side walls 62. Sockets 85 provide an electrical connectional to and physical mounting structure for light 80 are attached to the bracket center panel 84. Parallel legs 86 (one shown) extend outwardly from the opposed ends of center panel 84. Each leg 86 is screw secured or otherwise fastened to the adjacent ice bin side wall 62. Bracket legs 86 thus suspend the bracket 82 and light 80 in a position forward of the ice bin 24

A flat upper reflector panel 88, integral with center panel 84, extends diagonally upward from the center panel. Below the center panel 84, on one side of the center panel 84, bracket 82 is shaped to have a bottom reflector panel 90. Reflector panel 90 extends diagonally forward and downward from the bottom edge of the center panel 84 with which the panel 90 is integral.

Adjacent reflector panel 90, bracket 82 is formed to have a component housing 92. While not individually identified, it is appreciated that component housing 92 has a back wall and a floor panel. Component housing 92 also has opposed side walls that close the ends of the housing. The side walls are perpendicular to the housing back wall and floor panel. One side wall is adjacent the bottom reflector panel 90; the second side wall is adjacent the side edge surface of bracket center panel 84. Component housing 92 opens to the front of the dispenser 20. An access panel 94 is removably mounted over the housing 92 to close the interior space of the housing 92. The walls and floor of the housing 92 are such that, when access panel 94 is in place, the access panel 94 is planar with the bottom reflective panel 90.

Electrical components 93 that regulate the actuation of the dispenser 20 are disposed in the component housing 92. A transparent or translucent panel (not illustrated) provided with an aesthetic design and/or advertising is normally disposed over light 80 and bracket 82. This panel functions as the front face of the dispenser 20.

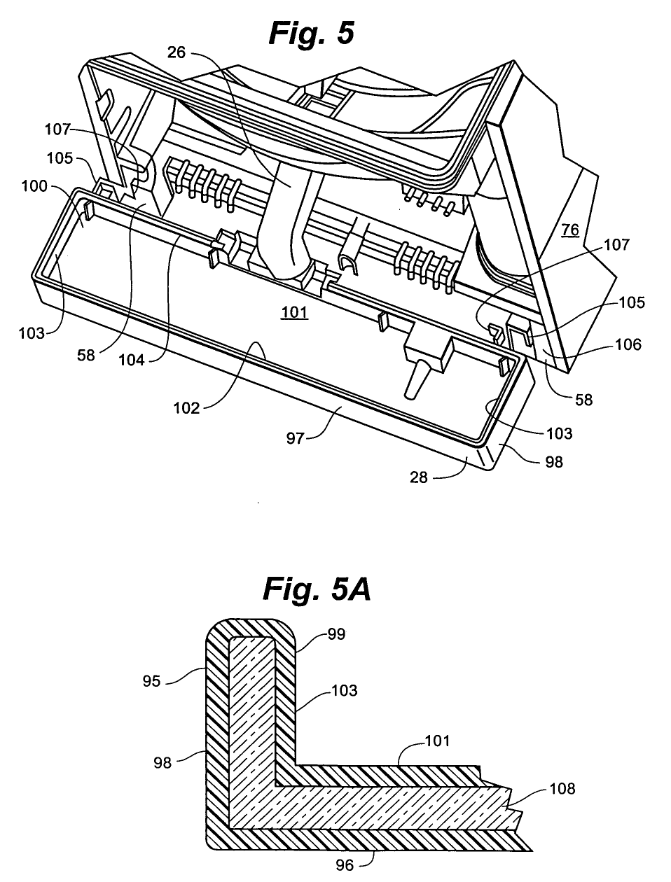

The drip pan 28, seen best in FIGS. 5 and 5A, is formed from plastic. More particularly, the drip pan 28 is formed to have two separate, spaced apart panel sections. A first panel section 95 forms the pan base 96. Panel section 95 also forms the outwardly-directed front wall 97, side walls 98 and rear wall (not identified) of drip pan 28. A second panel section 99 forms the top surface 101 of the drip pan 28 and the inwardly-directed front wall 102, side walls 103 and rear wall 104 of the drip pan 28. Section 99 is formed so that the pan front side and rear walls, 102, 103 and 104, respectively, extend upwardly from the pan top surface 101. This provides the drip pan 28 with void space 100 in which liquid and ice are contained.

Drip pan panel section 95 is further formed to have two L-shaped mounting hooks 105 that extend rearwardly from the section rear wall. Each front post 58 integral with the dispenser base 38 has a forwardly-directed mounting block 106. Each post 58 is shaped to define an L-shaped slot 107 that extends inwardly from the front of the post mounting block 106 for accepting a separate one of the pan hooks 105. Slots 107 open upwardly into the top of the mounting blocks 106. Drip pan 28 is attached to the rest of dispenser 20 by positioning the pan so that the hooks 105 are above the mounting blocks 106 and sliding the pan downwardly so that the hooks seat in slots 107.

Insulation 108 is disposed between the pan panel sections 95 and 99, respectively. From FIG. 5A it should be appreciated the insulation 108 is located between the opposed pairs of front walls 97 and 102, side walls 98 and 103 and rear walls 104 and between the base 96 and top surface 101. The drip pan 28 may be constructed in two pieces; sections 95 and 99 may be molded separately. Alternatively, rotational molding or blow molding may be used to make pan sections 95 and 99 as a single unit.

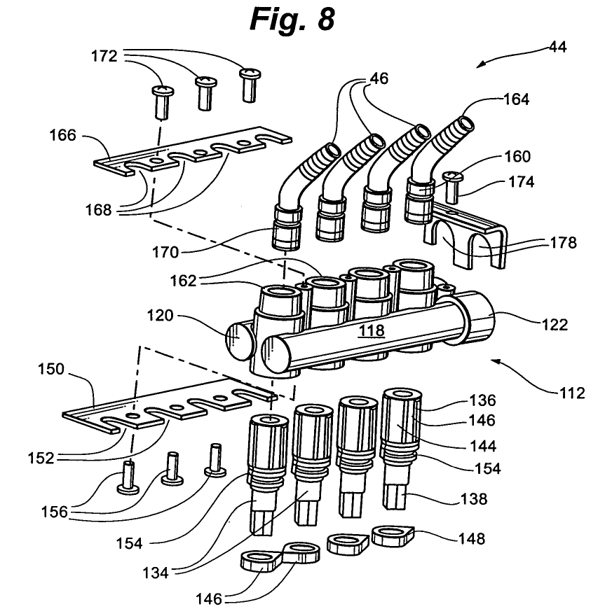

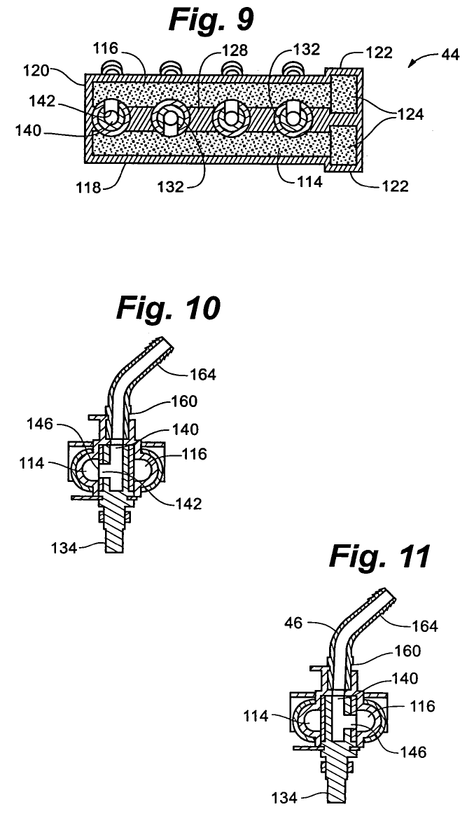

A manifold 44 of the dispenser 20 of this invention is now described in detail by reference to FIGS. 6-9. The manifold 44 includes a body 112. Body 112 has two parallel, closed end bores 114 and 116. In the depicted version of the invention, the body 112 has two generally tube shaped members 118 and 120, each of which is closed at one end, that define bores 114 and 116, respectively. A collar 122 is disposed over the open end of each member 118 and 120. Collars 122 define counterbores 124 that open into bores 114 and 116. Counterbores 124 are dimensioned to receive the free ends of outlet tubes 176 (FIG. 3) that extend from cold plate 40. A block 128 of solid material extends between manifold body members 118 and 120 along the length of the members.

Manifold body 112 also includes plural, linearly aligned and spaced apart valve housings 130. Valve housings 130 project above and below tube members 118 and 120 and block 128. Each valve housing 130 is generally cylindrically shaped and formed to define an axially extending through bore 132. Valve housing through bores 132 are perpendicular to bores 114 and 116. The manifold body 112, including the valve housings 130, are further dimensioned so that each valve housing through bore 132 extends through block 128 and intersects both bores 114 and 116.

A valve member 134 is mounted in each valve housing through bore 132. Each valve member 134 includes a valve body 136 disposed in the through bore 132 and a valve stem 138 that projects downward from the valve housing 130. Each valve body 136, as seen in FIG. 10, is shaped to define a closed end bore 140 that extends downwardly from the top of the valve body. A port 142 that opens into the circular side wall of the valve body 136 is formed in the side wall of each valve body 136. Each port 142 opens into the adjacent valve body bore 140.

In the illustrated version of the invention, a sleeve 144 is disposed around the outer circumferential surface of each valve body 136. Sleeves 144 are formed with through holes 146 that have the same diameter as valve body ports 142. Each sleeve 144 is positioned over the associated valve body 136 so that the sleeve through hole 146 is in registration with the valve body port 142. Sleeves 144 are tightly fitted over the valve bodies 136 to move with the valve bodies. Sleeves 144 are not closed-ended. Therefore, sleeves 144 do not impede fluid flow from the top of the valve member bores 140 into the valve housing bores 132.

An indicator ring 146 is fitted around each valve stem 138. Each indicator ring 146 has a tear-drop-shaped outer cross sectional profile. Thus, each indicator ring 146 has a single, triangularly shaped, outwardly directed indicator tab 148. Indicator rings 146 are press fit around the valve stems 138 to which the rings are attached to rotate with the stems. Collectively, the indicator rings 146 are mounted to the valve stems 138 so that when each valve member 134 is in a first setting, the indicator tabs 138 point in a first common direction. When the valve members 134 are in a second setting, indicator tabs 138 point in a second common direction opposite the first direction.

A single valve clip 150 holds the valve members 134 to the manifold body 112. Valve clip 150 is a plate formed to define a number of U-shaped notches 152; one notch for each valve member 134. Each valve stem 138 is shaped to have an annular groove 154 around an exposed circumferential section of the stem. Once valve members 134 are seated in valve housing bores 132, the valve clip 150 is slipped into position so the edge surfaces of the clip that define notches 152 seat in separate valve body stem grooves 154. Fasteners 156 hold the valve clip 150 to the manifold body 112. In the depicted version of the invention, fasteners 156 lock into sleeves 158 formed integrally with the valve body 112. Each sleeve 158 is located between a separate pair of valve housings 130. Sleeves 158, for reasons apparent below, extend outwardly from body block 128 to project above and below manifold body members 118 and 120.

Not shown are O-rings that may be fitted around the ends of the base of each valve body 136. Each O-ring is positioned in the associated valve housing bore 132 to function as a seal between the base of the valve body 136 and the adjacent inner circumferential wall of the valve housing 130.

A dole fitting 46 is mounted in the open end of each valve housing 130. In some versions of the invention, the dole fittings 46 are rotatably mounted in the valve housings 130. This allows the outlet end of each fitting 46 to be optimally positioned to facilitate the connection of the complementary hose line 47. In the depicted version of the invention, each dole fitting 46 has a tube shaped base 160. Each fitting base 160 seats in an open ended neck 162 that is part of the associated valve housing 130. Housing necks 162 have an outer diameter smaller than that of the rest of the housings 130. Each dole fitting 46 has an outlet spike 164 that is integral with and extends above the fitting base 160. The outlet spikes 164 are axially angularly offset from the fitting bases 160.

A common dole fitting clip 166 holds the individual dole fittings 46 in the valve housings 130. Dole fitting clip 166 is a plate shaped to have a set of U-shaped notches 168; one notch for fitting 46. Each dole fitting base 160 is formed to define, in an exposed circumferential section, an annular groove 170. Once the dole fittings 46 are seated in the valve housing necks 162, clip 166 is positioned over the manifold body 112. The outer perimeter surfaces of the dole fitting clip 166 that define the individual notches 168 seat in the grooves 170 of the adjacent dole fittings 46. Fasteners 172 hold the dole fitting clip 166 to the manifold body 112. The fasteners 172 lock into threaded bores formed in open ends of sleeves 158 that project above manifold body members 118 and 120.

Not shown, but understood to be present in some versions of the invention, are O-rings each of which extends around a separate dole fitting base 160. Each O-ring forms a liquid tight barrier between the fitting base 160 and the adjacent inner circumferential wall of the valve housing neck 162.

Mounting clips 174 suspend each manifold 44 above the cold plate 40. As seen by reference to FIG. 3, integrally attached to the cold plate 40 are two pairs of L-shaped outlet tubes 176. Each outlet tube 176 is connected to one of the cold plate conduits 41 through which either the carbonated or non-carbonated water flows. Each pair of tubes 176 is associated with a separate one of the manifolds 44. One tube 176 of each pair of tubes 176 supplies carbonated water. The second tube 176 supplies non-carbonated water. Not illustrated are flanges that are formed integrally with outlet tubes 176. Each flange extends circumferentially around the associated tube 176 and is positioned a slight distance rearward of the open end of the tube.

The assembled manifold 44 is mounted to dispenser 20 of this invention by fitting the manifold to the outlet tubes 176 so that the end of the tubes seat in manifold counterbores 124. Mounting clip 174 is generally in the form of a L-shaped bracket. Clip 174 has a generally short in length horizontal section and a longer, downwardly extending vertical section (sections not identified). The free end of the clip vertical section defines two parallel U-shaped notches 178, one notch for each outlet tube 176.

Once the manifold 44 is fitted to the outlet tubes 176, mounting clip 174 is fitted in position so that the tube flanges are sandwiched between manifold collars 122 and the vertical section of the clip 174. A fastener 180 that extends through the horizontal section of the clip 174 secures the clip to the manifold body 112. In the depicted version of the invention, the fastener 180 locks into a bore formed in a sleeve 182 formed integrally with the manifold body 118. Sleeve 182 projects upwardly between body collars 120.

Not shown are seals disposed in the manifold body counterbores 124 to effect liquid tight barriers between the manifold 44 and the cold plate outlet tubes 176.

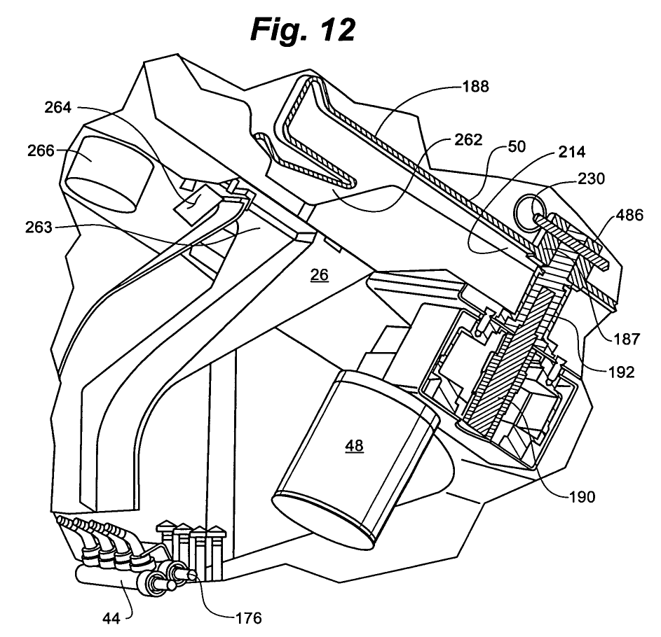

The agitator 50, now described by reference to FIGS. 12 and 13, is mounted to an inner surface of the ice bin front wall 66 so as to be disposed in the ice chamber 68. Agitator 50 has a cylindrical hub 186 from which a set of equiangularly spaced arms 188 extend radially outwardly. In the depicted version of the invention, arms 188 are in the form of bars. The ends of the arms 188 distal from the hub 186 have a U-shaped profile. The free end of each arm 188 is disposed under an adjacent section of the arm. Agitator hub 186 has an axially extending through bore 187.

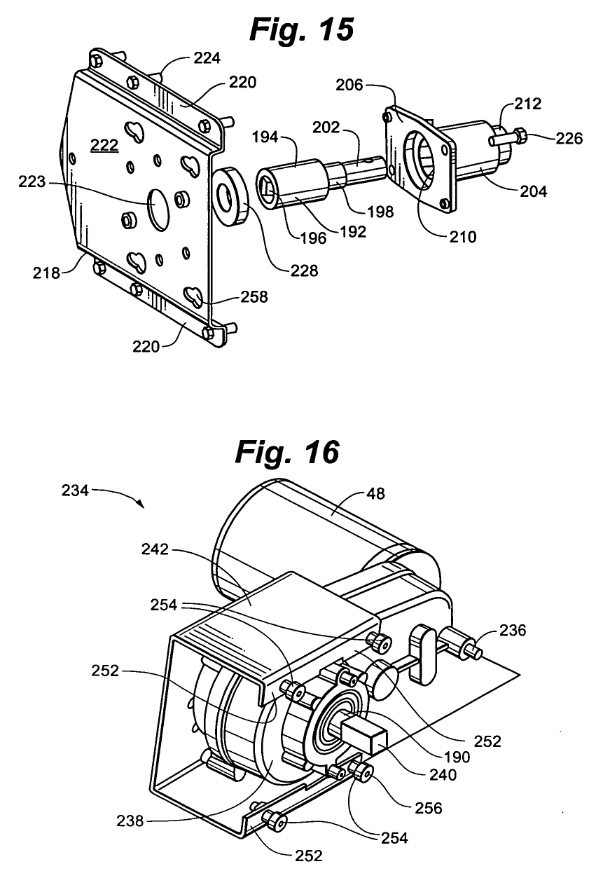

Power to rotate the agitator 50 comes from an output shaft 190 associated with motor 48 and a transfer shaft 192 mounted for rotation to the ice bin 24. As seen in FIGS. 14 and 15, transfer shaft 192 is a cylindrical member with a number of different sections. At one end, the transfer shaft 192 has a wide diameter base 194. The transfer shaft 192 has a closed end bore 196 that extends into the shaft base 194 from the bottom of the shaft. Transfer shaft 192 is formed so that bore 196 has a square cross sectional profile. This allows the motor output shaft 190 to be releasably coupled for rotation to the transfer shaft 192 as discussed below.

Extending forward from base 194, transfer shaft 192 has a shoulder 198. The transfer shaft 192 is formed so that shoulder 198 has a diameter less than that of the shaft base 194. The most forward portion of the shaft is a neck 202, which is immediately in front of the shoulder 198. Shaft neck 202 has a diameter less than that of shaft shoulder 198.

Transfer shaft 192 is rotatably fitted in a shell 204 that extends through the ice bin front wall 66. Shell 204 is generally in the form of a tubular structure. The outer end of shell 204, the end that extends inwardly from the outer surface of the ice bin front wall 66, is welded or otherwise secured to a mounting plate 206. In the depicted version of the invention, the shell 204 has a base section 208 with a diameter larger than that of the main body of the shell. Base section 208 defines a counterbore 210. The shell base section 208 is the portion of the shell that extends forward of ice bin front wall 66. Mounting plate 206 is attached to the open end of the shell base section 208.

Forward from the main body of the shell 204, the shell has a ring-shaped collar 212. Collar 212 has a diameter less than that of the main body of the shell 204.

Shell 204 is mounted in a through opening formed in the ice bin front wall 66 (opening not identified.) More particularly, the shell 204 is positioned so that the circular step between the shell base section 208 and the main body of the shell presses against the outer face of the ice bin front wall 66. The main body of the shell extends through the ice bin front wall 66. In the depicted version of the invention, the ice bin front wall 66 is formed with a raised island 214 that extends into the space that would otherwise form the ice chamber 68. The main body of the shell 204 extends through island 214. Shell collar 212 is disposed in the ice chamber 68.

A mounting bracket 218 attached to the outer surface of the ice bin front wall 66 holds shell 204 to the ice bin 24. Mounting bracket 218 is generally rectangular in shaped. The mounting bracket 218 is formed to have two opposed L-shaped feet 220 that extend the length of the bracket. A web 222, integral with the feet 220, extends between the feet. Mounting bracket 218 is positioned against the exposed surface of the ice bracket front wall 66 so that the coplanar surfaces of feet 220 press against the wall. Fasteners 224, which extend through openings in the coplanar surfaces of the feet 220, hold the bracket 218 to the ice bin front wall (bracket openings not identified). When the mounting bracket 218 is so secured to the ice bin 24, the bracket web 222 is spaced from the front wall 66 of the ice bin. Bracket web 222 is further formed to have a through hole 223.

When the mounting bracket 218 is mounted to the ice bin 24, bracket web 222 presses against plate 206 integral with shell 204. As part of this process, the mounting bracket 218 is positioned so that web hole 223 is concentric with longitudinal axis of shell 204. Fasteners 226 that extend through the plate 206 and bracket web 222 hold the shell 204 to the mounting bracket 218.

After the transfer shaft 192 is inserted in the shell 204 and prior to the fitting of the mounting bracket 218 over shell 204 a rubber, washer-shaped seal 228 is fitted in shell counterbore 210. Seal 228 forms a liquid-tight barrier around the outside of the transfer shaft 192.

Once the transfer shaft 192 is rotatably mounted in shell 204, the free end of the shaft neck 202 extends beyond the shell collar 212. Agitator 50 is coupled to the transfer shaft by seating the hub 186 over the shaft neck 192. More particularly, the agitator 50 is positioned so that the shaft neck 202 seats in hub bore 187. A cotter pin 230 (FIG. 12) removably holds the agitator hub 186 to the transfer shaft 192. Not identified are the concentric bores formed in both the agitator hub 186 and transfer shaft neck 202 in which the cotter pin 230 is seated.

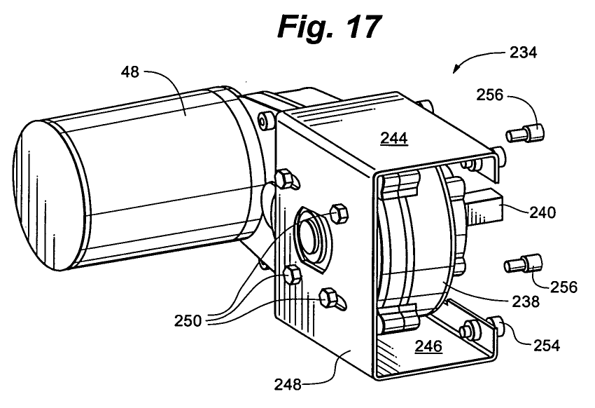

Motor 48 is part of a motor assembly 234, now described by reference to FIGS. 16 and 17, that is removably attached to the ice bin 24 and removably coupled to the transfer shaft 192. In the figures, the outer housing of the motor 48 and exposed end of a motor shaft 236 are shown. Motor assembly 234 also includes a gear assembly 238, the housing of which is shown. Output shaft 190 is part of the gear assembly 238 and extends rearward out of the gear assembly housing. Output shaft 190 has an exposed head 240 with a square-shaped cross sectional profile. More particularly, shaft head 240 is shaped to facilitate the fitting of the head into the bore 196 of the transfer shaft 192. Shaft head 240 is also dimensioned so that, when in bore 196, the output shaft 190 is able to laterally shift a small distance relative to the longitudinal axis of the transfer shaft 192. In the depicted version of the invention, output shaft 190 is laterally offset from motor shaft 236. A section of the gear assembly 234, including the gear assembly housing, is laterally offset from the motor 48.

A slider bracket 242 is disposed over the section of the housing gear assembly 234 offset from the motor 48. Slider bracket 242 is a one-piece, three-sided structure. The slider bracket 242 has opposed top and bottom plates 244 and 246, respectively. A front plate 248 connects top and bottom plates 244 and 246, respectively. The slider bracket 242 is positioned so that top plate 244 and bottom plate 246 are, respectively, located immediately above and below the gear assembly 238. Bracket front plate 248 extends across the forward-facing surface of the gear assembly 248. Slider bracket 242 is formed so that the distance between the top and bottom plates 244 and 246, respectively, is equal to the top-to-bottom mounting bracket web 222. Fasteners 250 that extend through opening in the bracket front plate 248, hold the slider bracket 242 to the gear assembly 238.

Slider bracket 242 is further shaped to have two parallel, spaced apart flanges 252. Each flange 252 extends perpendicularly from the end of a separate one of the bracket top and bottom plates 244 and 246, respectively. Flanges 252 are directed inwardly toward each other and are coplanar and parallel to the bracket front plate 248. Two mounting pins 254 extend outwardly, rearwardly from each of the flanges 252. Each pin 254 has a head 256 diameter wider than the part of the pin adjacent the surface of the flange 252.

The motor assembly 234 is mounted to the rest of the dispenser 20 by positioning the slider bracket flanges 252 against the mounting bracket web 222. The slider bracket 242 is so positioned by inserting the mounting pins 254 through the wide diameter sections of complementary keyhole shaped openings 258 in web 222. Simultaneously, output shaft head 240 is inserted through bracket web hole 223 and seated in the transfer shaft bore 196.

Once the slider bracket 242 is positioned against the mounting bracket 218, the whole of motor assembly 234 is slid laterally. Specifically, the motor assembly 234 is shifted position so the mounting pins 254 extend into the narrow spaced sections of the mounting bracket openings 258. This movement releasably couples the motor assembly 234 to the ice bin 24. Shaft head 240 is smaller in cross sectional area than transfer shaft bore 196. Therefore, output shaft 190 makes this lateral shift relative to the transfer shaft 192 and remains rotatably coupled to the transfer shaft 192.

Returning to FIG. 12, it can be seen that the ice bin front wall 66 is formed with a discharge opening 262. In the depicted version of the invention, the discharge opening 262 is formed in wall 66 above the location where agitator 50 is rotatably mounted to the ice bin 24 and within the area subtended by the agitator arms 188. Ice chute 26 is mounted to the bin front wall 66 to form a conduit that extends from the open face of discharge opening 262.

An ice gate 263 is moveably located immediately in front of the open face of discharge opening 262. Ice gate 263 is displaced by an arm 264 that is pivotally attached to the bin front wall 66 (attachment assembly not shown. A solenoid 266 is fixedly secured to the bin front wall 66 by a mounting bracket 268. Solenoid 266 has a plunger (not identified) attached to arm 264 that displaces the arm. As seen in FIG. 1, an ice release lever 270 is attached to the beverage dispenser 20 and located below the open end of ice chute 26. Based on a sensor (not illustrated) detecting the pivotal movement of the ice release lever 270, the electronic control circuit actuates solenoid 266 to cause the displacement of arm 264. The displacement of the arm 264 results in the movement of gate 263 away from the ice bin discharge opening 262.

Beverage dispenser 20 of this invention selectively dispenses beverages and ice. Beverages are dispensed from each dispensing head assembly 22 by placing a container under a nozzle 32 so as to shift the associated lever arm 34. Upon receiving the signal that the lever arm is depressed, the control circuit opens the valves integral with the dispensing head assembly 22 to cause the liquids forming the selected beverage to be dispensed. Ice is dispensed by placing the container under the open end of chute 26 so that lever 270 is depressed. Upon this event being sensed, the control circuit actuates solenoid 266 to cause gate 263 to open. Gravity then causes ice to be discharged from ice bin 24 through chute 26 into the container.

Prior to being discharged from the dispenser 20, the liquids forming a blended beverage flow through cold plate 40. The thermal energy integral with these liquids is transferred through the cold plate 40 and the base of the ice bin 24 into the ice chamber 68. This energy transfer cools the liquids prior to their discharge. Foam 59 insulates the side and bottom surfaces of cold plate 40 from the surrounding surfaces of the dispenser base 38. This insulation reduces the extent to which the cooling of the cold plate 40 results in a like cooling of base 38. Since base 38 of the dispenser 20 is not appreciably cooled, the extent to which condensate forms on the outer surface of the base is similarly reduced. The reduction in the formation of this condensate results in a like minimization of the formation of puddles of condensate inside the dispenser 20.

Similarly, insulation 108 minimizes the extent to which ice and cooled beverage that collect inside the drip pan 28 cause the outer surfaces of drip pan panel section 95 to cool. Thus, the difference between the ambient temperature and the temperature of the drip pan 28 outer surfaces is kept relatively small so that minimal, if any, condensate forms on these surfaces. The reduction in the formation of condensate on these surfaces minimizes the extent that condensate puddles form around the outside of the drip pan 28.

Moreover, drip pan 28 is attached to the dispenser base 38 by static fastening members, hooks 105, integral with the pan. This makes removing and replacing the drip pan 28 so the liquid collected can be disposed and the pan cleaned a relatively simple task. Since one is not required to spend time unscrewing and resetting screw type fastening members, the time required to remove and replace the drip pan 28 is also kept to a minimum.

Manifolds 44 regulate which one of the carbonated or non-carbonated waters is flowed to the individual dispensing head assemblies 22. The specific type of water supplied, carbonated or non-carbonated, is set by simply rotating the manifold valve member 134 associated with the dispensing head assembly 22. For example, as seen by reference to FIG. 10, when the valve member 134 is in a first position, fluid communication is established from bore 114 through the valve body 136 into the dole fitting 46. As seen in FIG. 11, when the valve member 134 is in a second position, the valve body 136 established a fluid path from bore 118 to the fitting 46. This feature of the dispenser 20 makes changing the type of water supplied to a particular dispensing head assembly 22 an easy task to perform without tools and that takes a brief amount of time to accomplish.

The positions of the tabs 148 integral with the indicator rings 146 provide an easy to view indication regarding the specific type of water being supplied through the manifold 40 to the attached dispensing head assemblies 22.

Cladding panels 77 are removably attached to the outer surfaces of ice bin 24. This makes changing the panels 77, which form the outer skin of the beverage dispenser 20, an easy task to perform.

Motor assembly 234, including motor 48 and output shaft 190, are removably attached to the rest of the dispenser 20. The fasteners used to hold assembly 234 in place, pins 254, are not, themselves, removed from the assembly 234. This makes removing and reinstalling the motor assembly 234 for repair or replacement a relatively simple task.

Also, motor assembly 234 is mounted to the ice bin 24 so as to be laterally spaced away from the carbonator 42. As seen in FIG. 3, the motor assembly 234 is mounted so as to be located adjacent the ice bin side wall 62 opposite the side wall 62 to which the carbonator 42 is mounted. This minimizes the effort required to access motor assembly 234 for repair or replacement.

Beverage dispenser 20 of this invention is further designed so that carbonator 42 is mounted to the dispenser 20 in the front of a forwardly directed opening immediately behind head units 30. Carbonator 42 is thus positioned at a location where it is easy to access for repair or replacement.

Similarly, components 93 that regulate the operation of beverage dispenser 20 are disposed in component housing 92. Housing 92 is forward-opening and located immediately above the dispensing head assemblies 22. All that one is required to do to access the inside of housing 92 is to remove the transparent panel that forms the front face of the dispenser and remove access panel 94. Thus, accessing electrical components 93 for repair or replacement is likewise a simple task that takes a minimal amount of time to perform.

Individually and collectively, the above features minimize the amount of time and effort required to perform both normal operating maintenance and advanced repair operations on beverage dispenser 20 of this invention.

The above description is limited to one specific version of the beverage dispenser 20 of this invention. It should be appreciated that alternative versions of the beverage dispenser 20 may be constructed. For example, there is no requirement that each of the above-described features be incorporated in all the versions of the beverage dispenser 20.

Similarly, the features of the invention may have constructions different from what has been described. In some versions of the invention, ice bin 24 and base 38 may be molded as a single unit. The molding is formed to define a slot in which cold plate 40 is seated. This version of the invention is constructed so that insulation is packed in the sections of the unit that surround the bottom and side surfaces of the cold plate slot. Once the cold plate 40 is seated in the slot, a strip of insulating material is secured to the unit to close the slot. A benefit gained by this version of the invention is that it eliminates the need to foam in place secure the cold plate 40 while also minimizing the unwanted transfer of heat from the outer surfaces of the unit to the cold plate.

The bracket that defines the forward opening component housing 92 may not also be the same bracket or only bracket that supports lights that illuminate the beverage dispenser 20.

Other assemblies may be used to removably attach drip pan 28 to the rest of the beverage dispenser 20. For example, clip mechanisms with spring-biased tongues can releasably hold the drip pan 28 in place. To release the drip pan one is merely required to depress a tab/tabs to cause the locking tongue/tongues to retract away from the associated dispenser surface/surfaces against which it/they normally abut. It should likewise be appreciated that the fastening member, such as the hook or spring biased tongue, that holds the drip pan 28 to the base 38, may be attached to the base.

Manifold 44 similarly may have constructions different from the one shown. For instance, the individual valve members that control which one of the carbonated or non-carbonated waters is flowed to a particular dispensing head assembly 22 may have different constructions. In one possible alternative construction, each valve member is slidably mounted to the manifold body. In this construction of the invention, when the valve member is slid into a first position, one of the carbonated or non-carbonated waters is supplied to the associated outlet fitting. When the valve member is slid into a second position, the other of the non-carbonated or carbonated waters is supplied.

It should likewise be appreciated that, in other versions of the invention, the manifold and valve members may be designed to offer more than bistate selection of carbonated or non-carbonated water for supply to a dispensing head assembly 22. In some versions of the invention, the valve members may be designed so as to further selectively allow both carbonated and non-carbonated water to be flowed simultaneously to a dispensing head assembly 22. This design may be accomplished by providing the valve members with plural flow ports and/or asymmetric ports that open into the flow bores. These versions of the invention make it possible to, through the manifold and by selective valve positioning, deliver beverage-forming water that is highly carbonated, lightly carbonated or non-carbonated.

Further, the manifold 44 may not just be used as the device that selectively supplies carbonated or non-carbonated water to the dispensing head assemblies 22. In some versions of the invention, a manifold may be provided that receives different types of syrups. By setting the valve members integral with the manifold the type of syrup supplied to a particular dispensing head 22 is selectively set. For example, the manifold may be supplied with sugared and sugar-free versions of a syrup for a particular beverage. Then, by setting the manifold valves, the technician can set which of a plurality of dispensing head assemblies 22 dispense which versions of the beverage.

Similarly, components other than indicator tabs may be integral with the manifold to provide a quick, visually determined indication of the carbonated/non-carbonated water setting of a particular valve member. For example, colored bars that are selectively exposed and concealed by static frames integral with the manifold may be provided. Whether or not a particular bar is visible or concealed is a function of valve state.

It should likewise be appreciated that motor assembly 234 may have alternative features than what has been described. For instance, locking members that are moveable relative to the assembly 234 yet are permanently attached may be provided to removably hold the motor assembly to the rest of the dispenser 20. These locking members may be in the form of clamping devices. Use of these locking members in some versions of the invention eliminates the need to provide the slider bracket. Alternatively, these locking members may be permanently and moveably attached to the ice bin 24. In these versions of the invention, once the motor assembly 234 is fitted against the ice bin 24, the locking members are positioned against the motor assembly and locked against the motor assembly.

Also, alternative means may be provided to removably couple the output shaft 190 to the transfer shaft 192. For example, in versions of the invention in which moveable locking members are integral with the motor assembly, there would be no reason to dimension the output shaft 190 so that shaft 190 shifts position relative to the transfer shaft 192. In versions of the invention wherein it is desirable to shift the position of the motor assembly, the output shaft can be made retractable. As part of the motor assembly removal and reinstallation processes, the output shaft is placed in a retracted state. Once the motor assembly is properly positioned with regard to the rest of the beverage dispenser 20, the output shaft 190 is placed in an extended state to engage the transfer shaft 192 for rotation.

Moreover, in some versions of the invention, the transfer shaft may be eliminated. In these versions of the invention, output shaft 190 is dimensioned to extend through the wall of the ice bin 24 to which the motor 48 is mounted. The wall is formed with a through bore to accommodate the output shaft. A bearing assembly seats in this through bore to provide an insulated low friction seal around the output shaft 190. This version of the invention eliminates both the need to provide a transfer shaft and the need to have some sort of assembly to couple the output shaft to rotation to a transfer shaft.

Therefore, it is an object of the appended claims to cover all variations and modifications that come within the true spirit and scope of this invention:

What is claimed is:

1. A beverage dispenser comprising:
a plurality of dispensing head assemblies, each said dispensing head assembly dispensing a beverage;
an ice bin and an ice chute that extends from said ice bin, said chute having an opening adjacent said dispensing head assemblies;
an agitator disposed in said ice chamber;
a motor assembly having an output shaft, said motor assembly being positioned adjacent said ice bin and said output shaft positioned to releasably engage said agitator so that said output shaft rotates said agitator; and
at least one fastening member permanently attached to said ice bin or said motor assembly for removably engaging the other of said motor assembly or said ice bin to removably hold said motor assembly to said ice bin and said output shaft to said agitator.

2. The beverage dispenser of claim 1, wherein:
a transfer shaft is rotatably mounted to said ice bin so as to extend into the ice chamber;
said agitator is mounted to said transfer shaft;
said motor assembly output shaft and said transfer shaft are collectively formed so that said motor assembly output shaft is releasably couplable to said transfer shaft to rotate said transfer shaft.

3. The beverage dispenser of claim 1, wherein:
a mounting bracket is mounted to said ice bin, said mounting bracket being formed with a plurality of slots; and
said motor assembly includes a plurality of pins, said pins being said fastening members and positioned to seat in the mounting bracket slots.

4. The beverage dispenser of claim 1, wherein
said motor assembly includes: a motor having a motor shaft; a gear assembly attached to said motor that receives rotational power from said motor shaft; and said output shaft is part of said gear assembly; and
said at least one fastening member extends from said gear assembly.

5. The beverage dispenser of claim 1, wherein:
a transfer shaft is rotatably mounted to said ice bin so as to extend into the ice chamber, and said transfer shaft is formed with a bore that is open from outside of said ice bin;
said agitator is mounted to said transfer shaft;
a mounting bracket is mounted to said ice bin, said mounting bracket being formed with a plurality of slots; and
said motor assembly includes a plurality of pins, said pins being said fastening members and positioned to seat in the mounting bracket slots, wherein:
said mounting bracket slots are shaped so that said pins can move between a first position wherein said pins are removable from said mounting bracket and a second position wherein said pins are locked to said mounting bracket; and
said motor assembly output shaft and said transfer shaft are collectively formed so that: upon the seating of said pins in the mounting bracket slots, said output shaft seats in the transfer shaft bore; said output shaft is able to move laterally in the transfer shaft bore; and said output shaft and said transfer shaft rotate in unison.

6. A beverage dispenser comprising:
a base;
a plurality of dispensing head assemblies, each said dispensing head assembly having an outlet through which a beverage is dispensed;
an ice bin defining an ice chamber and an ice chute that extends from said ice bin, said chute having an opening adjacent said dispensing head assemblies;
a drip pan removably attached to said base and located below said dispensing head nozzles and the chute opening, said drip pan having:
panel sections that are spaced apart to define a space therebetween and that are further formed to define a catch space below the dispensing head outlets and the chute opening; and
insulation disposed in the space between said panel sections; and
a fastening member permanently attached to said base or said drip pan for removably engaging the other of said drip pan or said base to hold said drip pan to said base.

7. The beverage dispenser of claim 6, wherein:
said drip pan panel sections are shaped to define a pan base; front, side and rear outwardly-directed walls that extend upwardly from said pan base; front, side and rear inwardly-directed walls that are parallel with and spaced apart from, respectively, said front, said side and said rear outwardly-directed walls; and a top surface contiguous with said front, said side and said rear inwardly-directed walls that is recessed so that said top surface, in combination with said front, side and said rear inwardly-directed walls define said catch space; and
said insulation is located between said front walls, between said side walls, between said rear walls and between said base and said top surface.

8. The beverage dispenser of claim 6, wherein said fastening member is integrally formed with one of said drip pan panels.

9. The beverage dispenser of claim 6, wherein:
said fastening member is integrally formed with one of said drip pan panels; and
said base is formed with a slot for removably receiving said fastening member:

10. A beverage dispenser comprising:
a base having outer surfaces;
an ice bin disposed above said base;
a cold plate through which beverage-forming liquid flows, said cold plate positioned between said base and said ice bin;
thermally insulating foam disposed between said cold plate and the outer surfaces of said base;
a plurality of dispensing head assemblies, each said dispensing head assembly connected to said cold plate to receive beverage-forming liquid from said cold plate; and
an ice chute that extends from said ice bin.

11. The beverage dispenser of claim 10 wherein:
said cold plate is disposed over an outer surface of said base; and
said foam secures said cold plate to said base.

12. The beverage dispenser of claim 11, wherein:
said base is formed to have side walls that have top edges and a top surface that is recessed relative to the top edges of the side walls; and
said cold plate is disposed above said base top surface between said base side walls.

13. The beverage dispenser of claim 11, further including:
an agitator disposed in said ice bin;
a motor assembly having an output shaft, said motor assembly being positioned adjacent said ice bin and said output shaft positioned to releasably engage said agitator so that said output shaft rotates said; and
at least one fastening member permanently attached to said ice bin or said motor assembly for removably engaging the other of said motor assembly or said ice bin to removably hold said motor assembly to said ice bin and said output shaft to said agitator.

14. A beverage dispenser comprising:
a plurality of dispensing head assemblies, each said dispensing head assembly dispensing beverage-forming liquid;
a manifold, said manifold having:
a body, said body defining first and second separate fluid spaces;
a plurality of outlet fittings connected to said body, said outlet fittings being connected to said dispensing head assemblies; and
a plurality of valve assemblies attached to said body, each said valve assembly being associated with a separate said outlet fitting and having a moveable valve member that is formed with a through bore in communication with the associated said outlet fitting, the valve member being positioned relative to the manifold body so that: when the valve member is in a first position, the through bore establishes a fluid communications path from the manifold body first fluid space into the associated said outlet fitting; and, when the valve member is in a second position, the through bore establishes a fluid communications path from the manifold body second fluid space into the associated said outlet fitting.

15. The beverage dispenser of claim 14, wherein said manifold body is formed so that first and second fluid spaces are closed end bores.

16. The beverage dispenser of claim 14, wherein
each said valve assembly includes a valve housing integral with said manifold body and said valve housings are located between the first and second manifold body fluid spaces; and
said valve members are located in said valve housings.

17. The beverage dispenser of claim 14, wherein said valve assemblies are further configured so that:
when each said valve member is in the first position, fluid communications from the manifold body second fluid space into the associated said outlet fitting is blocked; and
when each valve member is in the second position, fluid communications from the manifold body first fluid space into the associated said outlet fitting is blocked.

18. The beverage dispenser of claim 14, wherein said valve members are rotatably mounted to said manifold body.

19. The beverage dispenser of claim 14, further including an indicator attached to each said valve member, each said indicator being attached to the associated said valve member so that, when the valve member is in the first position, said indicator is in a first state and, when said valve member is in the second position, said indicator is in a second state separate from the first state.

20. The beverage dispenser of claim 14, further including:
a source of non-carbonated water; and
a carbonator connected to said source of non-carbonated water that produces carbonated water, and wherein,
said source of non-carbonated water supplies non-carbonated water to the manifold body first fluid space and said carbonator supplies carbonated water to the manifold body second fluid space.

21. A beverage dispenser comprising:
a frame;
a plurality of dispensing head assemblies attached to a side of the frame, each said dispensing head assembly dispensing a beverage;
a carbonator attached to a surface of said frame adjacent the front side of the frame, said carbonator supplying carbonated water to at least one of said dispensing head assemblies;
an ice bin comprising a plurality of walls that define an ice chamber and an ice chute that extends from said ice bin, said chute having an opening adjacent said dispensing head assemblies; and
a plurality of cladding panels, each said cladding panel being directly attachable to a separate wall of said ice bin and said cladding panels being individually removable and exchangeable.
